(19) United States
(12) Patent Application Publication
(10) Pub. No.: US 2009/0144907 A1
(43) Pub. Date: Jun. 11, 2009

(54) Systems and methods for manufacturing fire-retardant mattresses

(75) Inventors: Richard F. Gladney, Fairburn, GA (US); Michael S. DeFranks, Decatur, GA (US)

Correspondence Address: ROPES & GRAY LLP, PATENT DOCKETING 39/41, ONE INTERNATIONAL PLACE, BOSTON, MA, 02110-2624, US

(73) Assignee: Dreamwell, Ltd., Las Vegas, NV (US)

(21) Appl. No.: 12/283,866

(22) Filed: Sep. 16, 2008

Related U.S. Application Data
(60) Provisional application No. 60/994,169, filed on Sep. 18, 2007.

(51) Int. Cl. A47C 17/86; A47C 23/00; B23P 17/04

(52) U.S. Cl. 5/698; 5/716; 29/428

(57) ABSTRACT

The systems and methods described herein include, among other things, methods for manufacturing a fire-retardant mattress. In certain embodiments, the methods described herein employ an adhesive tape to secure a sock of fire resistant fabric to the exterior of a mattress core, rendering the mattress fire resistant. The mattress core may be a foam core, an innerspring core, or another type of core. The tape may be a two sided adhesive tape and the fire-retardant (FR) sock may be any suitable fire resistant material.

### CROSS-REFERENCE TO RELATED APPLICATIONS

This application claims priority to and the benefit of U.S. Provisional Patent Application No. 60/994,169, filed on Sep. 18, 2007, the entire contents of which are incorporated herein by reference.

### FIELD OF THE INVENTION

The systems and methods described herein relate to fire-retardant cushions such as mattresses and methods for manufacturing fire-retardant mattresses.

### BACKGROUND

Engineers and scientists have been developing mattresses with improved fire resistance and that reduce the likelihood that exposure to fire will cause the mattress to combust.

For example, bed pads have been developed that can be placed on top of a bed and cover the sides of a bed. These bed pads are generally made of fire retardant materials that protect the mattress from exposure to flame or heat and tend to reduce the likeliness that the mattress will catch on fire. Although these bed pads have been effective, they may be uncomfortable and unsightly. Consequently consumers have a tendency to remove these bed pads after a period of time and once removed the benefit of the bed pad is lost.

To address this issue, other mattress manufacturers have developed mattresses that have flame-retardant material built into the mattress. Typically, these mattresses may include a layer of fire-retardant material, such as fiberglass or metal foil that can be placed under the quilting and in the sides of the mattress. Again, these fire-retardant materials tend to work well in reducing the likelihood that the mattress will catch on fire. However, these materials are uncomfortable to sleep on and therefore consumers find them undesirable. Moreover, these materials have a tendency to dry out, become flaky, and break down. Consequently, the life expectancy of a flame-retardant mattress that includes a layer of fiberglass, or aluminum foil, may be significantly less than the expectant product life of a normal mattress.

Moreover, adding a barrier layer of material to the mattress requires the manufacturing line to be reworked and significantly adds to the cost of manufacturing a mattress. Thus, these mattresses have been costly to manufacture, have had reduced product lives, and are disfavored by consumers.

Other techniques for increasing the fire resistance of a mattress include wrapping the mattress core in a sock made of fire-retardant material. This technique can work well, but to do so the sock must be securely attached to the mattress and the sock must completely cover the exterior of the core, without leaving gaps or openings. Even a small gap in the fire-retardant material could allow a flame to contact and ignite the core.

To secure the sock to the mattress core, the manufacturer will sometimes sew the sock in place around the core. Although this technique can securely attach the sock to the mattress, it may also create small needle holes in the sock through which a flame could penetrate and may introduce potentially flammable thread throughout the fire-retardant covering.

To overcome these problems, some manufacturers have begun using glue and spray adhesives to attach the sock to the core. However, glues and spray adhesives may create unpleasant or toxic fumes, and glues and spray adhesives also create a substantial mess in the assembly area. For example over spray can leave adhesive on work benches and equipment and can cover sections of the mattress core with an unwanted layer of glue. In addition, gluing equipment (including fume hoods and safety equipment) is bulky, expensive, and requires frequent maintenance. Glue and spray adhesives also slow mattress production because time is required for drying or curing. There is also a potential for these adhesives to dry unevenly, resulting in a mattress that is warped or has poor tailoring.

Accordingly, there is a need in the art for a new method to affix a fire-retardant sock to a mattress core.

### SUMMARY OF THE INVENTION

The systems and methods described herein include cushion assemblies such as mattresses. For purposes of clarity, and not by way of limitation, the systems and methods may be described herein in the context of mattress assemblies. However, it will be appreciated that the principles described herein may be adapted to a wide range of applications. For example, the principles of this disclosure may be applied to couches where a cushion is affixed to a larger assembly. In addition, the principles may be applied to chairs, loveseats, sofas, daybeds, automotive seats, crib mattresses, fold-out couches, and folding mattresses. More generally, the systems described herein may be employed in any environment where it is desirable to provide cushioning support.

The systems and methods described herein include, among other things, methods for manufacturing a fire-retardant mattress. In certain embodiments, the systems and methods described herein employ an adhesive tape to secure a sock of fire resistant fabric to the exterior of a mattress core, rendering the mattress fire resistant. The mattress core may be a foam core, an innerspring core, or an other type of core. The tape may be a two sided adhesive tape and the fire-retardant (FR) sock may be any suitable fire resistant material.

The use of tape to affix a fire-retardant sock around a mattress allows for rapid mattress assembly. It also causes minimal mess and has no requirement for bulky gluing equipment or expensive ventilation systems. In addition, the tape methods described herein allow for the production of a better tailored mattress. The tape application is clean and neat and forms a consistently uniform mattress core, leading to a more pleasing finished product. In certain embodiments, the methods and systems described herein employ one or more strips of attachment material including VELCRO®. The attachment material may be fire or flame retardant VELCRO®.

In one particular practice, the fire-retardant sock is first pulled around and fitted over the mattress core. The sock can fit like a sleeve over the exterior of the mattress, covering the top and bottom and two sides of the mattress. Depending on whether the sock is open on both ends like a sleeve or closed at one end like a bag, at least one of the sides of the mattress core will be open after the FR sock is slid over the mattress core. To close the open side or sides so that the mattress core is sealed within the FR sock, small cuts are made in the openings of the sock, forming flaps of fire-retardant material. The flaps are then affixed to the core with two sided tape, although optionally this method may use one sided tape. On one side of the mattress, the side flaps are affixed to the core using two strips of two sided tape. Next, the top flap is attached to the core and previously affixed flaps using three strips of two sided tape. The bottom flap is then similarly attached to the previously affixed flaps. This process is then repeated on the other side of the mattress, resulting in a core that is completely ensheathed in fire-retardant material. Finally, the sock-wrapped core is enveloped in a mattress cover.

More particularly in one aspect, the systems and methods described herein include mattress assemblies. The mattress assemblies may comprise a mattress core, a fire retardant sleeve fitted over the mattress core and a mattress cover enclosing the fire retardant sleeve and the mattress cover. The mattress core may include at least one of a foam core, an innerspring core, a latex core and a visco elastic core. In certain embodiments, the fire retardant sleeve is attached to the mattress core with adhesive tape. The fire retardant sleeve may be attached to the mattress core along at least one of a left side surface, a right surface, a sleeping surface, a bottom surface, a head surface and a foot surface.

In some embodiments, the tape may include a two sided adhesive tape. The adhesive tape may include one or more or a plurality of adhesive tape strips. In certain embodiments, the adhesive tape includes one or more strips of at least one of one-sided adhesive tape and two-sided adhesive tape. The adhesive tape may include a fire retardant adhesive tape.

In certain embodiments, the fire retardant sleeve is configured as a sock having an opening on one end, and wherein the sock attaches to the mattress core near the opening. The sock may include one or more flaps formed from cuts made near the opening on the sock. The cuts may be mitered cuts. In such embodiments, the adhesive tape secures the flaps to the mattress core.

In certain embodiments, the fire retardant sleeve is configured as a tubular sleeve having two openings, and wherein the tubular sleeve attaches to the mattress core near the openings. The tubular sleeve may include one or more flaps formed from cuts made near the openings on the tubular sleeve. The cuts may be mitered cuts. In such embodiments, the adhesive tape secures the flaps to the mattress core.

In certain embodiments, the mattress cover includes a bottom material and a top material, wherein a zipper removably attaches the top material to the bottom material. In other embodiments, the mattress cover includes a bottom material, a top material and a side border material, wherein a plurality of zippers removably attach the top material to the side border material, and the side border material to the bottom material.

In another aspect, the systems and methods described herein include methods for manufacturing a mattress. The methods may comprise providing a mattress core and applying an adhesive tape to one or more surfaces of the mattress core. The methods may further comprise sliding a fire retardant sleeve having at least one opening over the mattress core and forming one or more flaps on the fire retardant sleeve by making cuts on the sleeve near the at least one opening. The methods may comprise securing the one or more flaps to the adhesive tape, thereby securing the fire retardant sleeve to the mattress core and disposing a mattress cover over the fire retardant sleeve and the mattress core.

In certain embodiments, the adhesive tape includes a two-sided adhesive tape having a backing layer on each side. Applying the adhesive tape may include removing the backing layer on one side and securing the adhesive tape to a surface of the mattress core. In certain embodiments, applying the adhesive tape includes applying one or more adhesive tape strips to the mattress core. Applying the adhesive tape may include applying one or more strips of at least one of one-sided adhesive tape and two-sided adhesive tape. The cuts formed may include mitered cuts.

In certain embodiments, securing the one or more flaps includes removing the backing layer on the other side of the adhesive tape and attaching the one or more flaps to the adhesive tape. The methods may further comprise trimming excess fire retardant sleeve material from the one or more flaps. In certain embodiments, the mattress cover includes a top material, a bottom material and a side border material, and wherein disposing the mattress cover includes disposing the top material on a top surface of the mattress core, disposing the bottom material on a bottom surface of the mattress core, and attaching a side border material to the top material and the bottom material along a side surface of the mattress core.

It should be understood from the foregoing summary and attached description that the present invention, in certain embodiments, provides an FR sock or FR cover that is comfortable to the user, easy to assemble and aesthetically pleasing.

### BRIEF DESCRIPTION OF THE DRAWINGS

The foregoing and other objects and advantages of the invention will be appreciated more fully from the following further description thereof, with reference to the accompanying drawings wherein;

FIG. 1 depicts a supporting fork on which to place a foam mattress core, according to an illustrative embodiment of the invention.

FIG. 2 depicts a foam mattress core disposed on the supporting fork, according to an illustrative embodiment of the invention.

FIG. 3 shows positioning of a piece of tape to which side flaps will be affixed, according to an illustrative embodiment of the invention.

FIGS. 4A and 4B depict preparation of a fire retardant sock, including (A) bunching and (B) stretching of the sock, according to an illustrative embodiment of the invention.

FIG. 5 depicts the result of sliding the sock around the foam mattress core, according to an illustrative embodiment of the invention.

FIG. 6 depicts a method of miter cutting the sock to form top, bottom, and side flaps, according to an illustrative embodiment of the invention.

FIG. 7 depicts a method of removing the second backing layer of the piece of tape, according to an illustrative embodiment of the invention.

FIG. 8 depicts a method of affixing the side flaps to the tape, according to an illustrative embodiment of the invention.

FIG. 9 depicts a method of trimming any excess sock from the side flap, according to an illustrative embodiment of the invention.

FIG. 10 depicts a method of affixing two pieces of tape to the foam mattress core, according to an illustrative embodiment of the invention.

FIG. 11 depicts a method of removing the second backing from the tape, according to an illustrative embodiment of the invention.

FIG. 12 depicts a method of pulling the top flap into position, according to an illustrative embodiment of the invention.

FIGS. 13A, 13B, and 13C depict a method of aligning the top flap to the foam mattress core (A), (B) an example of undesirable, excessive folds in the corners of the sock material, and (C) an example of sock material misaligned such that there is exposed foam.

FIG. 14 depicts a method of affixing the top flap to the tape, according to an illustrative embodiment of the invention.

FIGS. 15A and 15B depict a method of trimming any excess sock from the top flap, according to an illustrative embodiment of the invention.

FIG. 16 depicts a method of applying tape to which the bottom flap will be affixed, according to an illustrative embodiment of the invention.

FIG. 17 depicts a method of removing the second backing layer from the tape, according to an illustrative embodiment of the invention.

FIG. 18 depicts a method of affixing the bottom flap to the tape, according to an illustrative embodiment of the invention.

FIG. 19 depicts a method of trimming any excess sock from the bottom flap, according to an illustrative embodiment of the invention.

FIG. 20 depicts a fire retardant mattress core, according to an illustrative embodiment of the invention.

FIG. 21 illustrates a mattress cover, according to an illustrative embodiment of the invention.

FIG. 22 depicts a method of pulling the mattress cover over the fire retardant foam mattress core, according to an illustrative embodiment of the invention.

FIG. 23 depicts a method of flipping the fire retardant mattress core, according to an illustrative embodiment of the invention.

FIG. 24 depicts a method of aligning the bottom material of the mattress cover, according to an illustrative embodiment of the invention.

FIG. 25 depicts a method of aligning the border of the mattress cover with the bottom material of the mattress cover, according to an illustrative embodiment of the invention.

FIG. 26 depicts a method of zipping the border of the mattress cover to the bottom material of the mattress cover, according to an illustrative embodiment of the invention.

FIG. 27 illustrates a fire retardant mattress, according to an illustrative embodiment of the invention.

### DETAILED DESCRIPTION OF THE ILLUSTRATED EMBODIMENTS

To provide an overall understanding of the invention, certain illustrative embodiments will now be described, including a fire retardant mattress. However, the embodiments set out below are merely for the purpose of illustration and it will be understood by one of ordinary skill in the art that the systems and methods described herein may be adapted and modified for other suitable applications and that such other additions and modifications will not depart from the scope hereof.

As described in more detail below, the methods described herein, and the mattresses made through these methods, employ an adhesive tape to secure a sock of fire resistant (FR) fabric to the exterior of a mattress core, rendering the mattress fire resistant. In certain illustrative embodiments, the mattress core includes a foam core. The mattress core may include at least one of an innerspring assembly core, a latex core and a visco elastic core without departing from the scope of the invention. The tape may be a two sided adhesive tape and the FR sleeve or sock may be any suitable fire resistant material. The mattress core may have six surfaces including a sleeping surface and a bottom surface opposite the sleeping surface, a head surface and a foot surface, and a left side surface and a right side surface. The mattress core may be a standard size such as King, Queen, Full, or Twin, or may be a nonstandard size or shape. The core may be a foam core, an innerspring core, a combination of foam and spring core, a latex core, a visco elastic core, or another suitable type of core. The cores discussed below are mattress cores. However, any cushion, pillow or furniture pad may be made using the methods described herein and all such cushions, pillows, pads and furniture fall within the scope hereof.

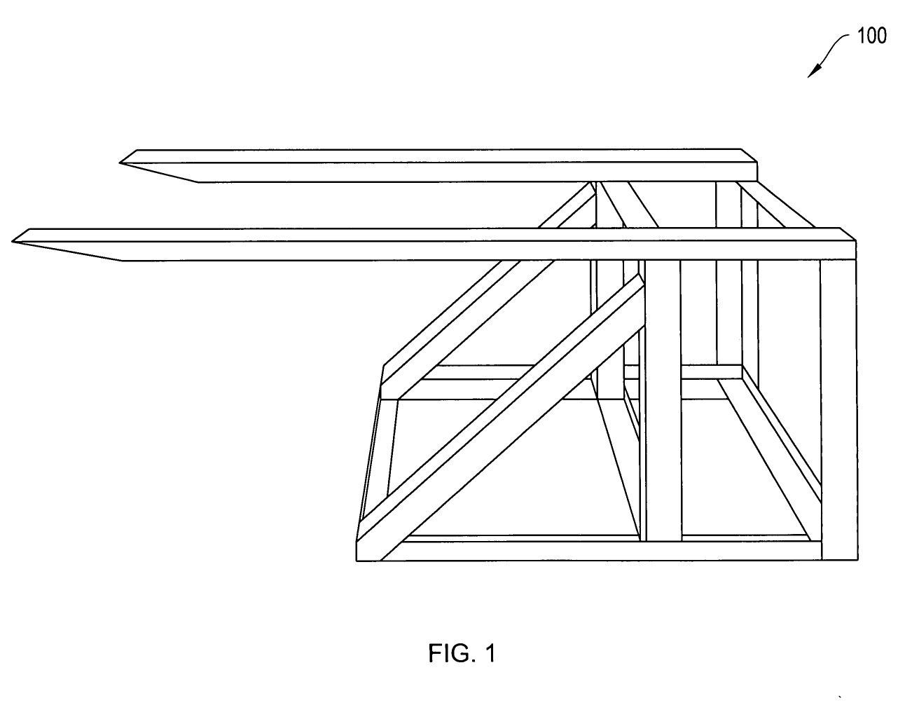

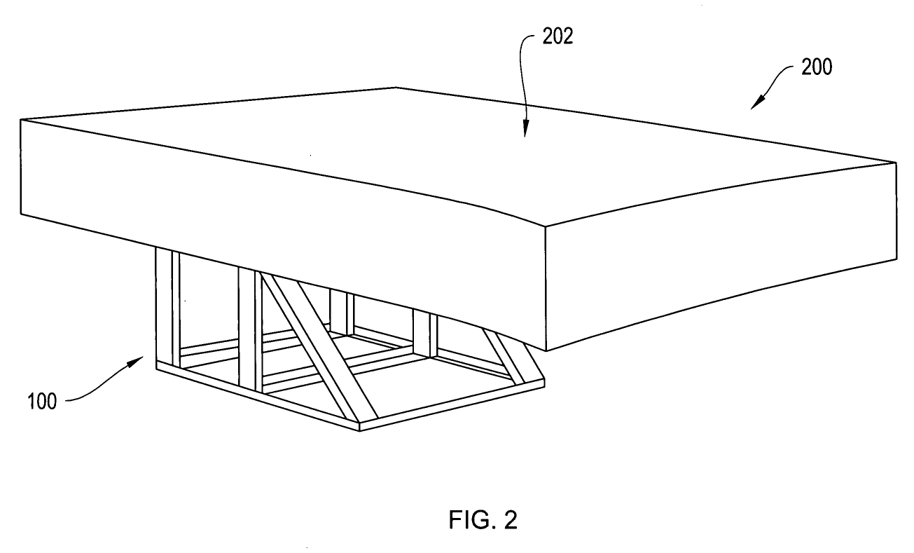

In one practice set out in the Figures, a foam mattress core is placed on a supporting fork 100, as shown in FIGS. 1 and 2, with the sleep surface 202 up and the head and foot hanging off the sides of the fork 100. The dimensional accuracy of the mattress core may optionally be checked to ensure that it is within a selected tolerance. Optionally, the foam mattress core is inspected for any damages or defects. Damage or defects may include tears or holes of any kind on the sleep surface. Damage or defects may also include tears or holes on the bottom foam that exceed 0.75″ in diameter. Damage or defects may also include seams (where the foam has been glued together) that are not flush, and edges that are not square.

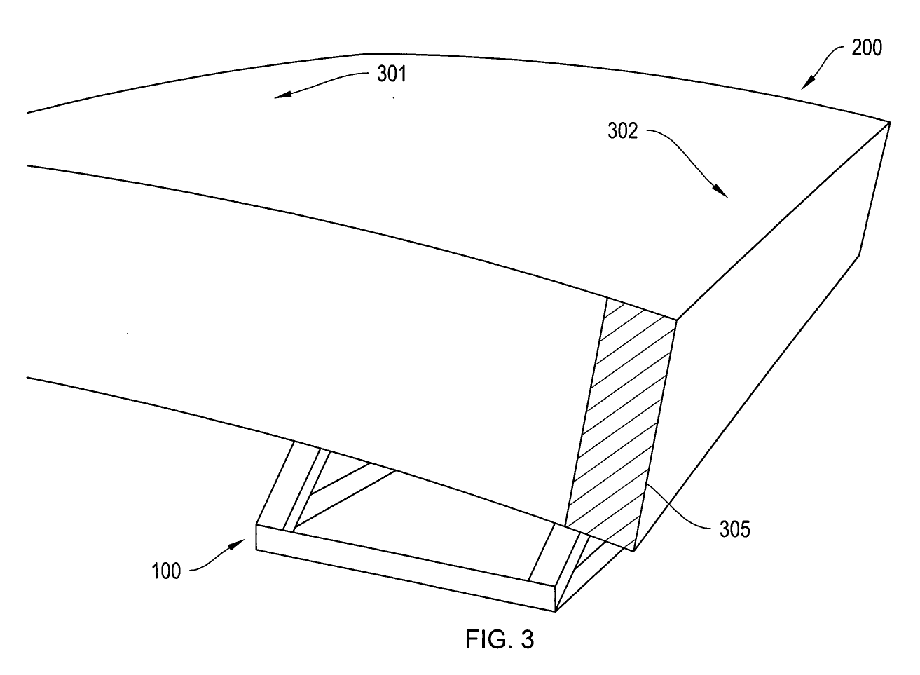

Turning to FIG. 3, the mattress core 200 is shown situated on the supporting fork 100. A piece of two sided tape 305 is applied at one corner 303 of the mattress core 200. In particular, with the depicted practice, the tape 305 is applied to the mattress core so that an adhesive strip is fixed to the right hand edge of the side of the mattress 200. The tape extends along the full edge of the mattress 200 from bottom to top. As noted in FIG. 3, the tape 305 is applied to the corner of the mattress 303. The tape may be fire retardant and may be one sided or two sided (e.g. being adhesive on a first side and a second side), having a first backing layer on the first side and a second backing layer on the second side. The tape 305 itself is clear, while the backing layer is an opaque brown color. The first backing layer may be removed from the tape to expose the adhesive. The tape does not contact the sleep surface.

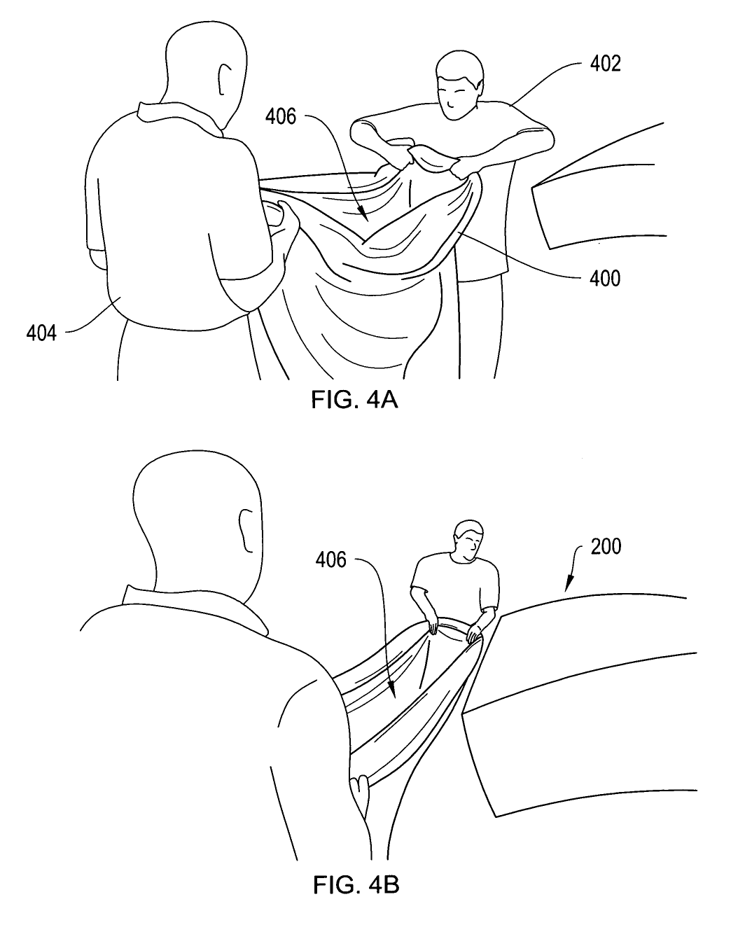

FIGS. 4A-B show the pre-cut fire-retardant sleeve or sock 400 being positioned to be slid over the mattress core 200. The sock 400 may be made of fabric, and may be cylindrical and open at two ends or bag-like with one end open and the other closed. A sock 400 may be a single cylindrical piece of fabric, or may be constructed from a planar piece of fabric taped to form a cylinder. The sock may be 130″ in dimension for a king size bed, 100″ in dimension for a queen size bed, 90″ in dimension for a full size bed, or 80″ in dimension for a twin/XL size bed. The sock material is preferably inspected to be free of dirt and any markings that could be seen through the mattress top cover. FIGS. 4A and B show that two people 402 and 404 hold up the sock 400 and bunch it at either end (FIG. 4A) and next they stretch the sock opening 406 and slide it around the mattress 200 (FIG. 4B).

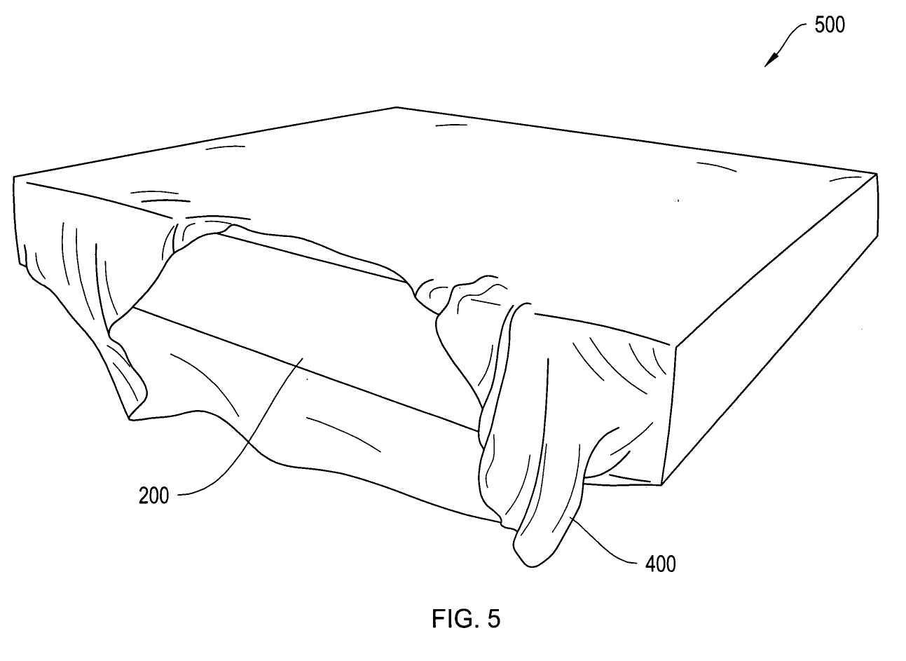

One then pulls the sock 400 over the mattress core 200 from side to side in a manner that leaves two of the sides covered and two of the sides of the mattress core exposed. FIG. 5 depicts the sock 400 once it is around the mattress core 200. In the illustrated embodiment, the left and right sides of the mattress core are exposed and the head and foot of the mattress core are covered by the FR sock 400. In an alternative embodiment, the openings of the sock are at the head and the foot of the foam mattress core.

Once the sock is fitted over the core, excess sock material overhangs each of the exposed sides by roughly the same length. One or more people then move the foam mattress core with the sock off the supporting forks and onto a socking table. Wrinkles are then pulled out of the sock.

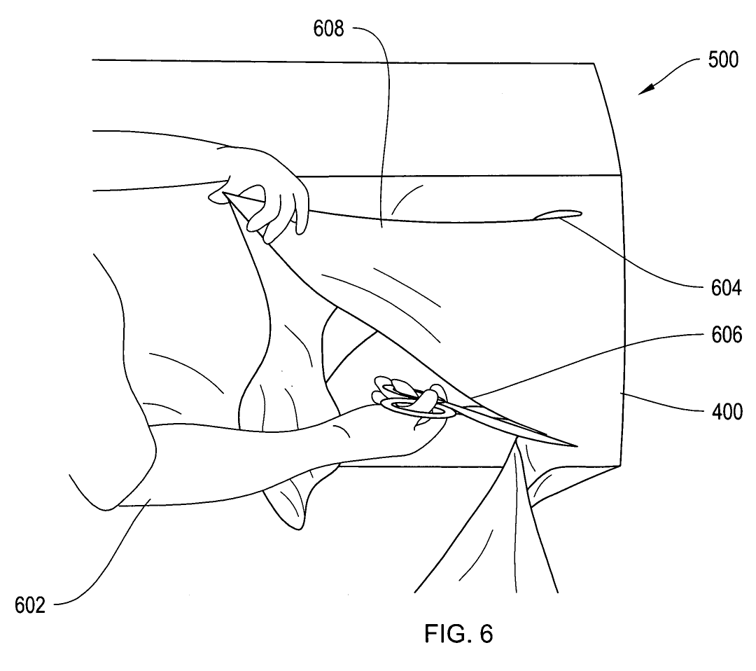

FIG. 6 depicts a person 602 cutting the sock material 400. In this depicted practice, one makes two incisions 604 and 606 at each corner. Each incision may be horizontal, and may be positioned one inch away from the top and bottom of the mattress. The cutting process is repeated on the other side of the mattress, resulting in each side having two side flaps 608, a top flap, and a bottom flap. In one embodiment, the cuts are made in the sock at the left side of the mattress. One may stop cutting at 3″, 2″, 1″, or 0.5″ away from the corner of the foam mattress core. In one practice, one stops cutting about 1″ away from the corner of the foam mattress core, however the incision may be 3″, 2″, 1″, or 0.5″ away from the nearest horizontal surface of the foam mattress core. In certain embodiments, the cuts are mitered cuts forming a miter cut edge. This edge may be taped to the mattress core or to another part of the fire-retardant sock.

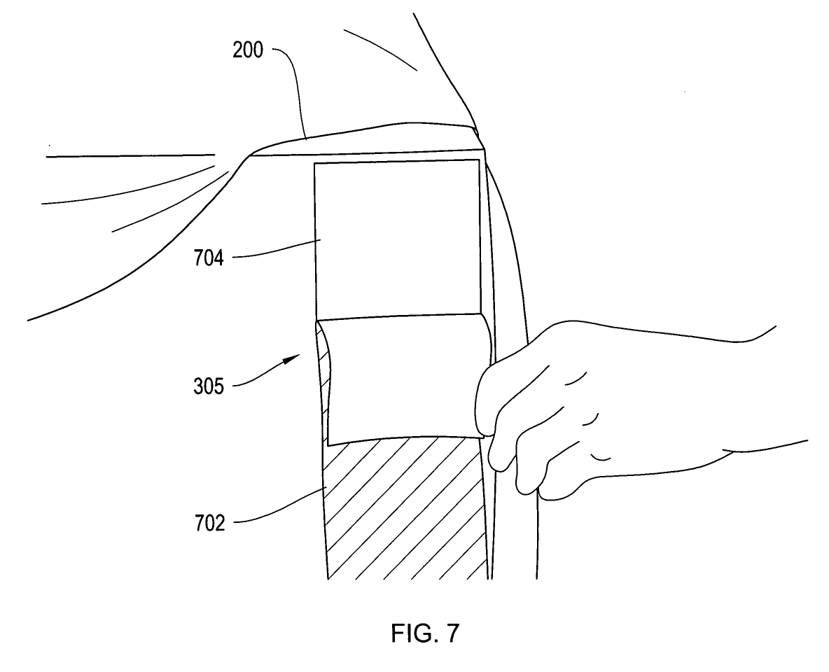

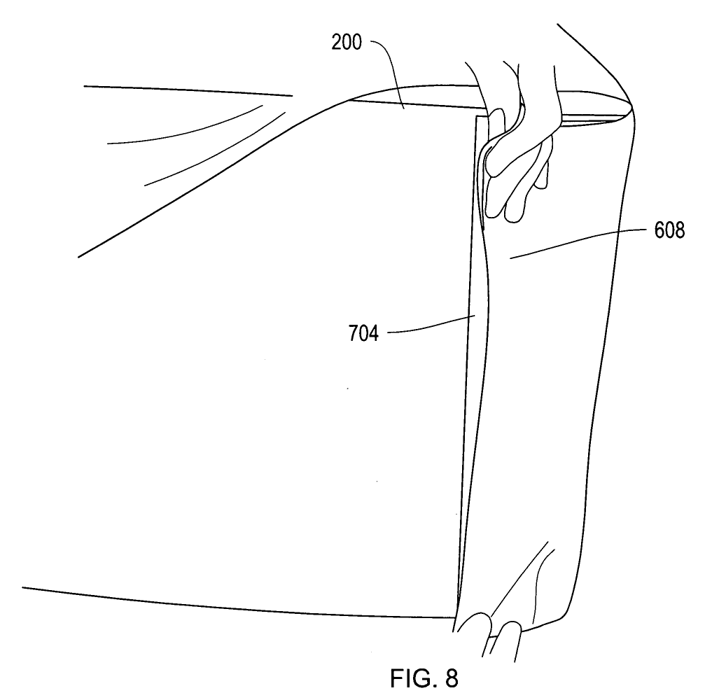

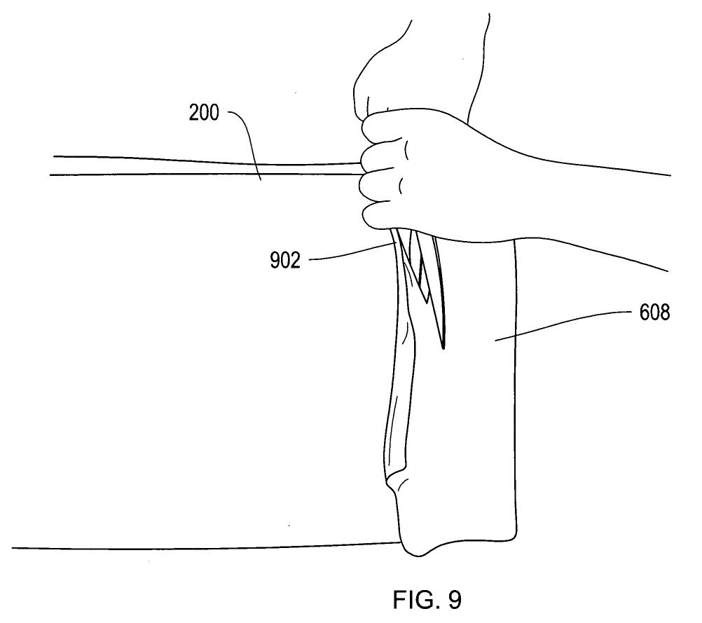

FIGS. 7, 8, and 9 depict the affixing of the corner of the sock 400 to the mattress core 200. In one embodiment, one removes the second backing layer 702 to expose the tape adhesive 704 in both corners (e.g. the head and foot corners at the left side of the mattress core) (FIG. 7). Next, the side flaps 608 of the sock 400 are gently pulled around the corners in a manner that does not pull in the corners of the mattress 200 (FIG. 8). The side flaps 608 are affixed to the tape adhesive 704, in a manner that results in a square edge on the foam mattress core. Scissors may be used to trim any excess sock 902 from the side flap 608 where the side flap is taped down (FIG. 9). In certain embodiments, the trimmed edges of the side flap are smoothed down.

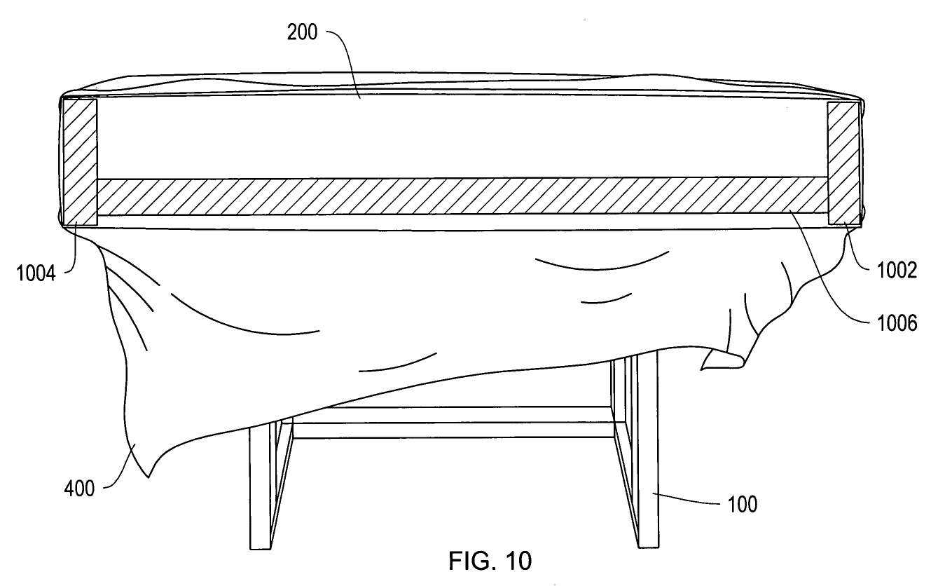

FIGS. 10 through 15 depict the taping down of the top flap of sock material, according to an illustrative embodiment of the invention. First, the backing is removed from three pieces of tape 1002, 1004 and 1006 and the tape is affixed to the mattress core 200 and/or portions of the side flaps 608. Two pieces are vertical 1002 and 1004 and are at the left and right ends of the side of the mattress 200 as depicted. The vertical pieces of tape 1002 and 1004 are affixed to the side flaps of the fire-retardant sock. The third piece of tape 1006 is placed in a horizontal line about one inch from the bottom of the side (FIG. 10). The horizontal strip may be 3″, 2″, 1″, or 0.5″ from the bottom edge of the foam mattress core. In one practice, the horizontal strip is 1″ from the bottom edge of the mattress core 200. The top and bottom flaps of the fabric hang free around the mattress.

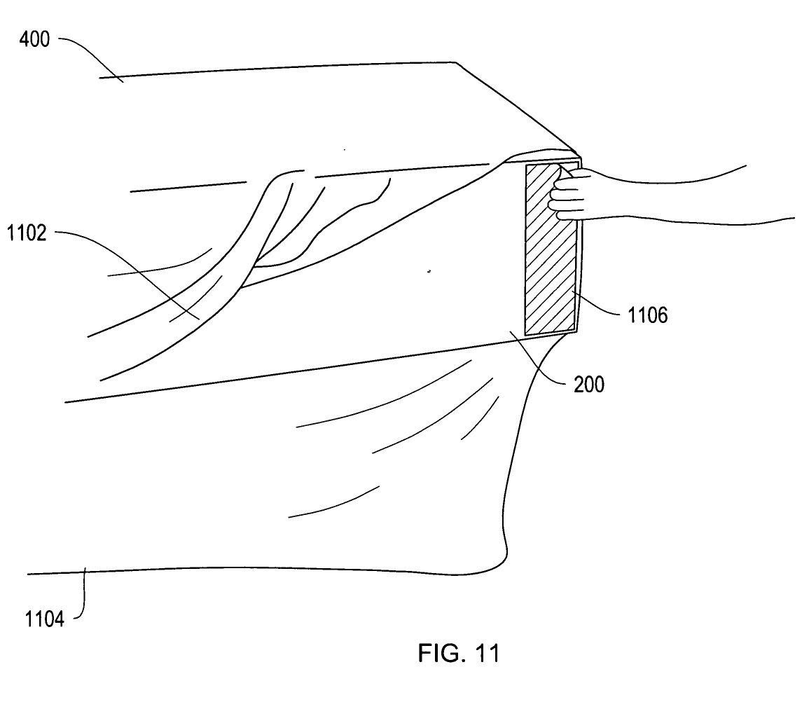

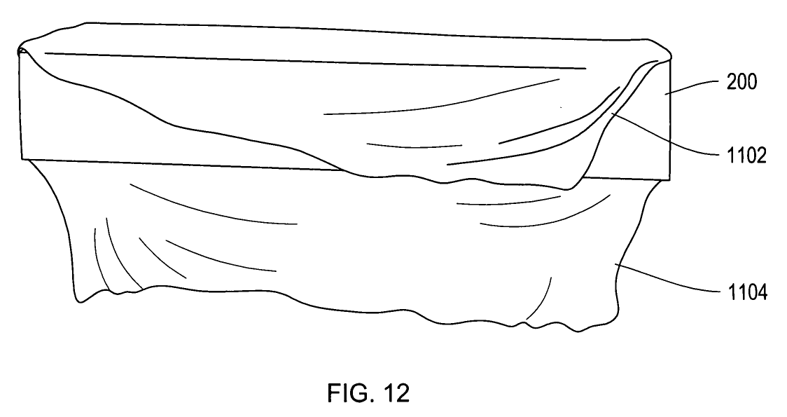

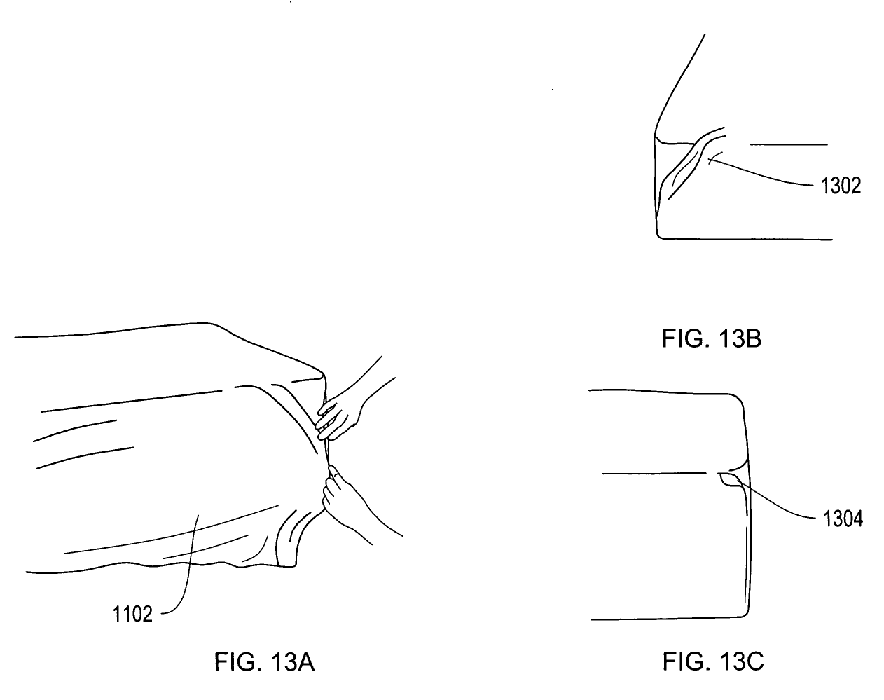

As shown in FIG. 11, the second backing layer 1106 is then removed from the tape 1002 to expose the adhesive. Next, the top flap of the sock 1102 is adhered to the mattress 200. The sock material may be gently pulled horizontally to remove wrinkles (FIG. 12). The top flap 1102 may be aligned with the edges of the corners of the mattress core and the top flap 1102 is affixed to the previously placed vertical strips of tape 1002 and 1004 (FIG. 13A). The sock material 400 is aligned such that there are limited or no excessive folds 1302 in the corners and there is no exposed mattress 1304. Examples of unwanted, excessive folds and unwanted, exposed mattress are shown are shown in FIGS. 13B and 13C respectively.

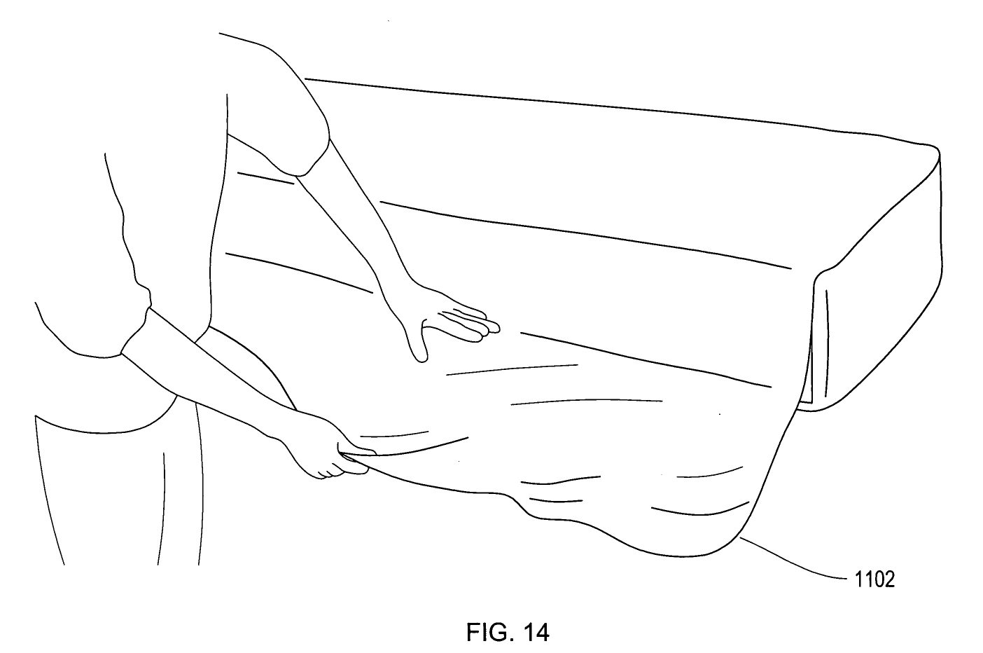

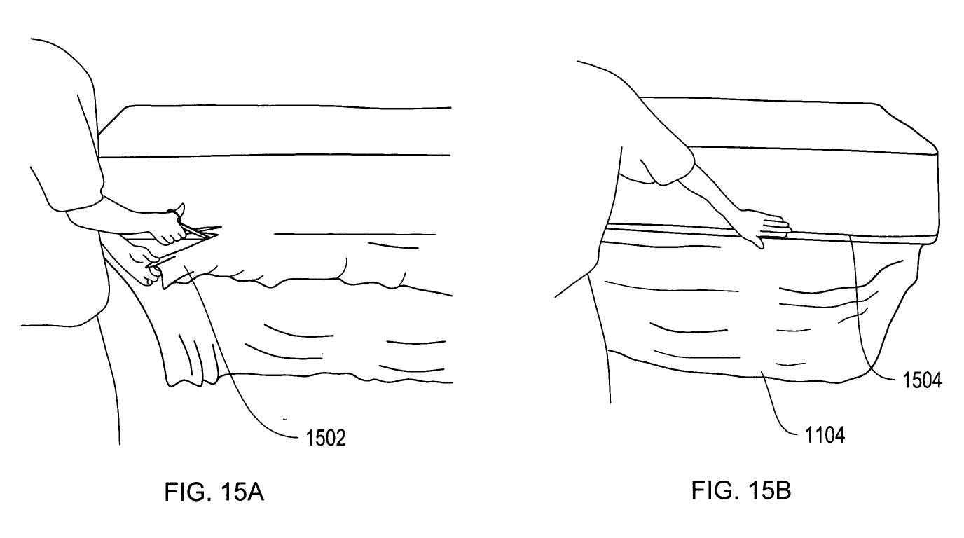

The corners now covered, the top flap 1102 of the sock is gently pulled down and pressed against the previously placed horizontal strip of tape 1006 (FIG. 14). Wrinkles are smoothed out as the sock is pressed into place. The top flap 1102 of the sock is affixed to the tape in a manner that yields a square edge to the mattress core, and does not round or otherwise distort the edge of the core. Excess sock material 1502 is trimmed from the top flap 1102 close to the area where the sock is taped to the mattress core (FIG. 15A). The cut edge 1504 is then smoothed down (FIG. 15B) and adhered to the depicted line of tape.

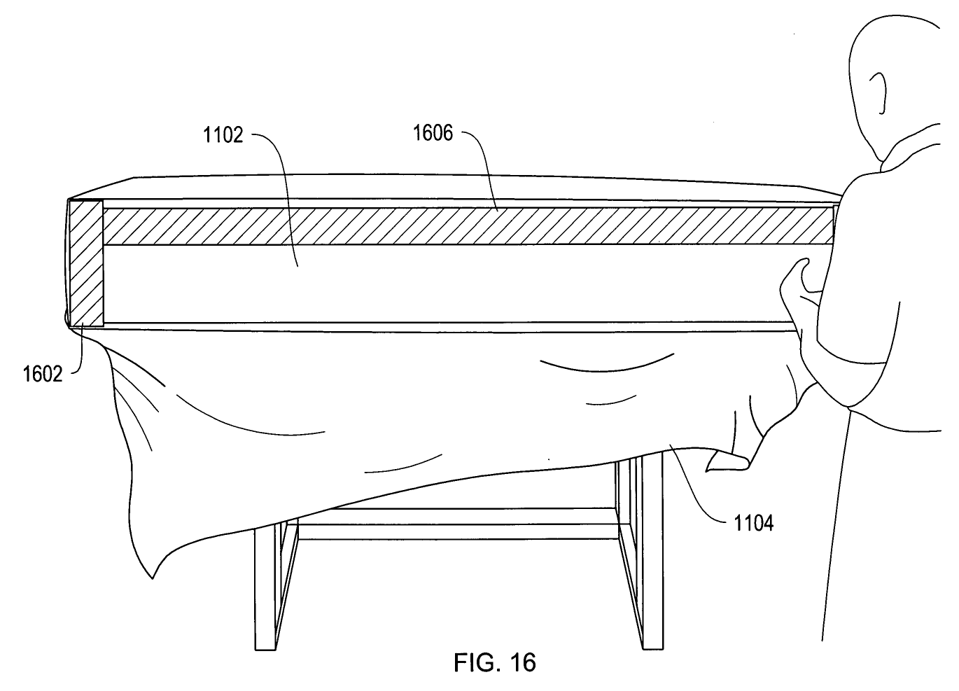

FIGS. 16 through 19 depict the bottom flap 1104 of the sock 400 being attached, similar to the attachment of the top flap 1102. First, a backing layer is removed from each of three pieces of tape 1602 and 1606. Two strips of tape are placed on the mattress core at the left 1602 and right ends (not shown) of the side of the mattress 200. The tape 1602 is oriented vertically, extending from the bottom to the top of the mattress core 200. One piece of tape 1606 is oriented horizontally and extends from the left end to the right end of the side of the mattress. In certain practices, the horizontal strip of tape is 3″, 2″, 1″, or 0.5″ from the top edge of the foam mattress core. In a preferred practice, the horizontal strip is 1″ from the top edge of the foam mattress core (FIG. 16). The bottom flap 1104 of the sock hangs down from the mattress 200.

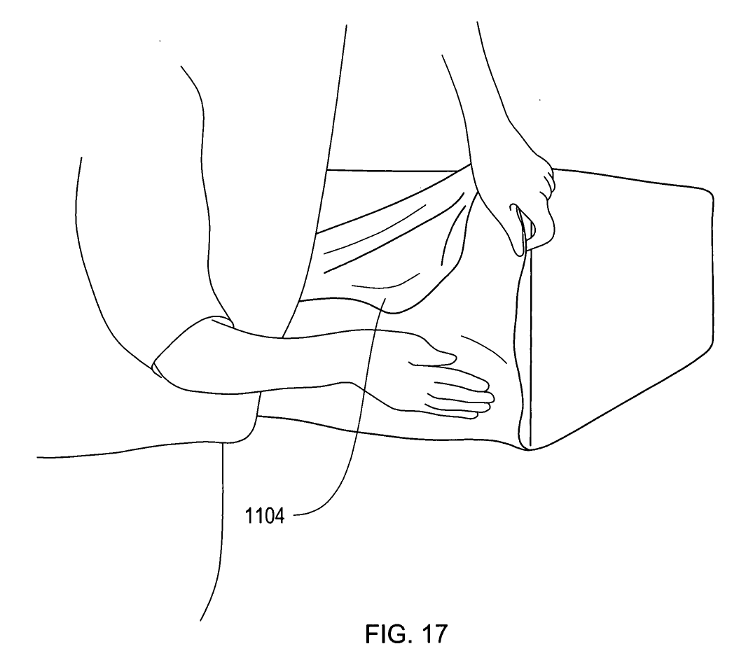

The second backing layer is removed from the tape to expose the adhesive (FIG. 17). One then tugs on the sock material from the bottom surface to pull out any wrinkles. The sock is gently pulled up from the bottom of the mattress core such that the bottom flap 1104 is pressed against the side of the mattress core (FIG. 17). The corners of the sock 400 are aligned with the corners of the mattress core, and the bottom flap 1104 is affixed to the exposed tape adhesive in a manner such that the edges of the mattress core are not rounded or distorted, and the mattress core has a straight edge, there are no excessive folds in the corners, and there is no exposed foam. Examples of unwanted, excessive folds (FIG. 13B) and unwanted, exposed foam (FIG. 13C) are shown.

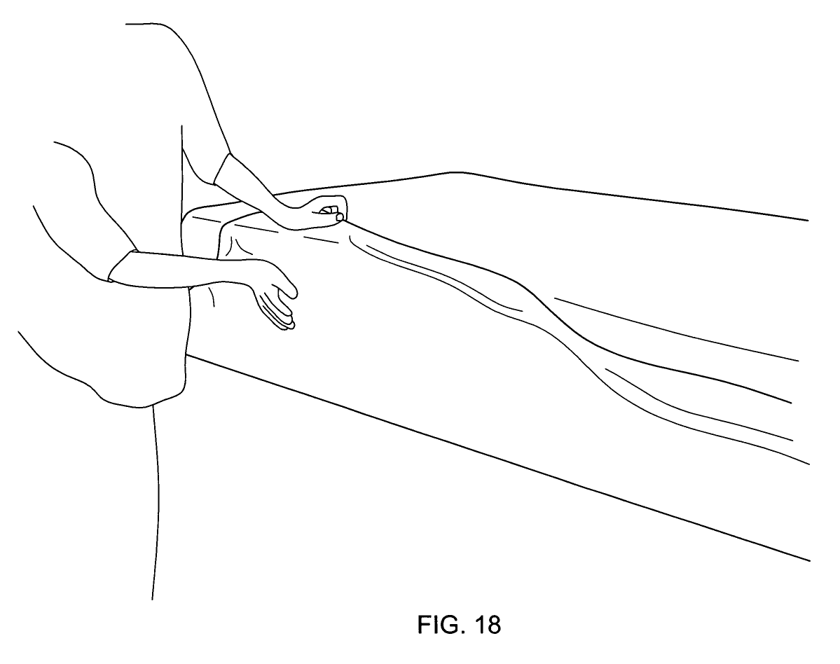

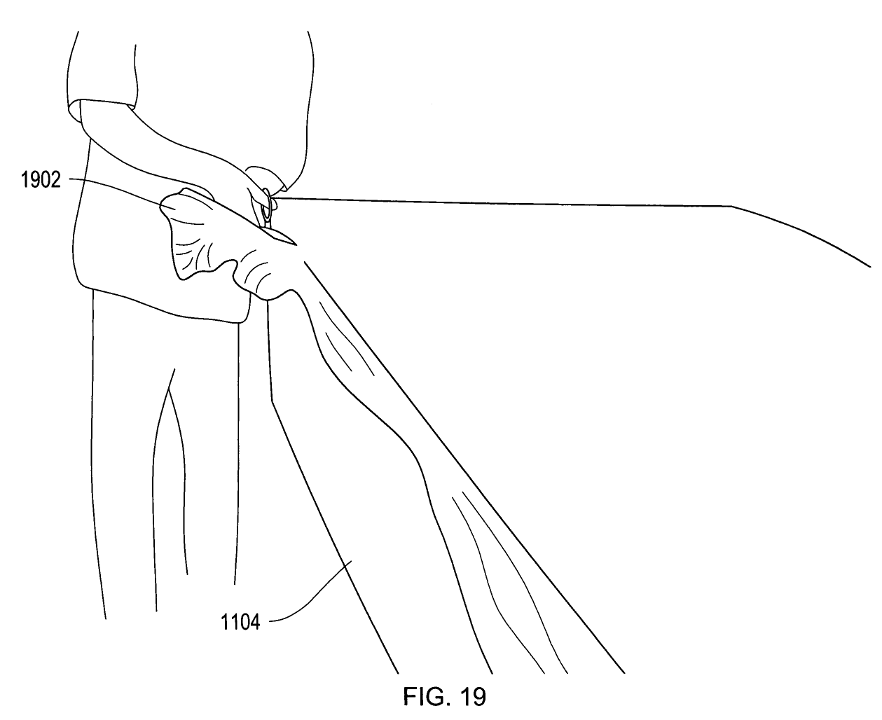

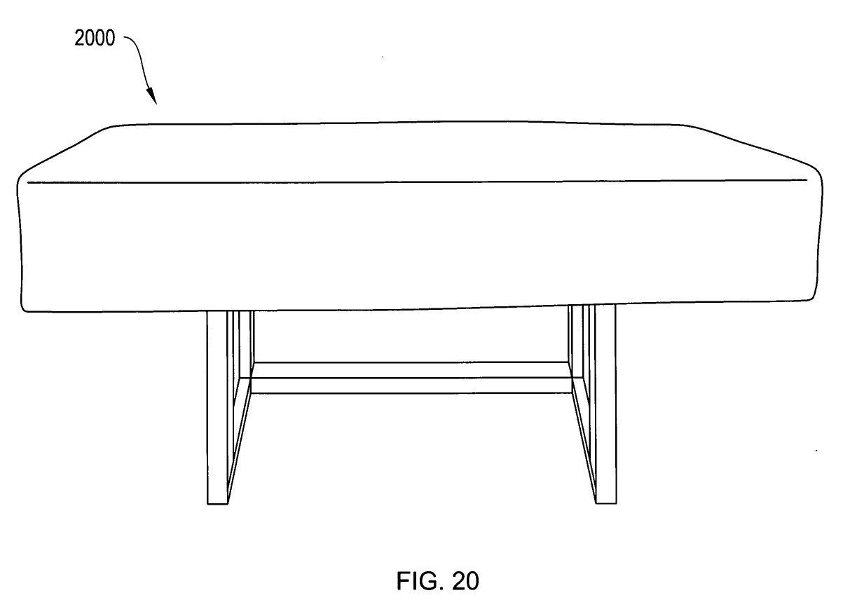

One gently pulls the bottom flap 1104 of the sock up and presses the bottom flap against the previously placed horizontal strip of tape 1602 and 1606 (FIG. 18), smoothing wrinkles as the sock is pressed into place. The bottom flap 1104 is affixed to the tape in a manner that yields a square edge to the foam mattress core 200, and does not round the edge of the core. Excess sock 1902 is trimmed from the bottom flap 1104 close to the point of adhesion to the tape, forming a cut edge (FIG. 19). The cut edge may be smoothed down close to the point of adhesion. The sock may be affixed to the right side of the mattress using the same method by which the sock was affixed to the left side of the mattress. FIG. 20 depicts a mattress assembly 2000 having a mattress core 200 substantially wrapped with a fire-retardant sock 400.

The fire-retardant mattress core may be inspected for quality control. One determines whether there are holes of any size in the fire retardant sock material. Holes may include tears and uncovered areas. A fire-retardant mattress may fail quality control testing if the sock material includes holes.

In an optional step in the process, the core is reviewed to determine whether there are any repaired areas on the portion of the sock contacting the sleep surface. Repaired areas may include areas repaired by the vendor of the fire-retardant sock or areas repaired by the person who assembles the fire-retardant mattress. A fire-retardant mattress core may fail quality control testing if it contains repaired areas on the portion of the sock contacting the sleep surface. In certain embodiments, repairs are acceptable on the sides and bottom of the fire retardant mattress. The core can be checked to determine whether all edges of the fire retardant mattress core are square and whether the sock material is smooth and free of wrinkles. A fire retardant mattress core may fail quality control testing if its edges are not square or wrinkles are present.

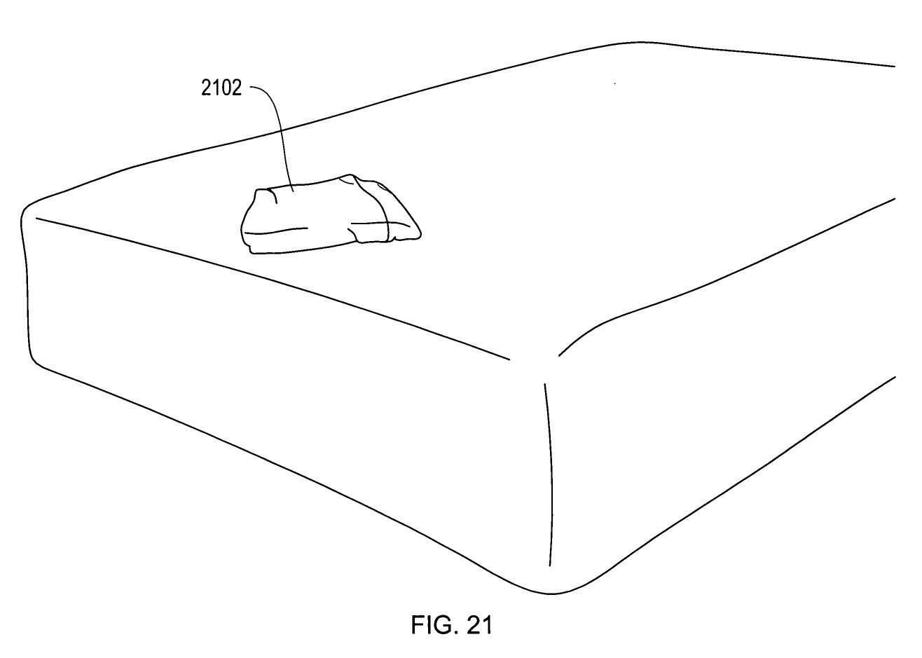

FIG. 21 depicts a folded mattress cover 2102. A law tag may be affixed to the mattress cover. The mattress cover may comprise a bottom material, a top material, and a border that is joined to the bottom material with a zipper. The top material, bottom material, and border may be made of fabric, and may additionally include layers of padding and/or quilting.

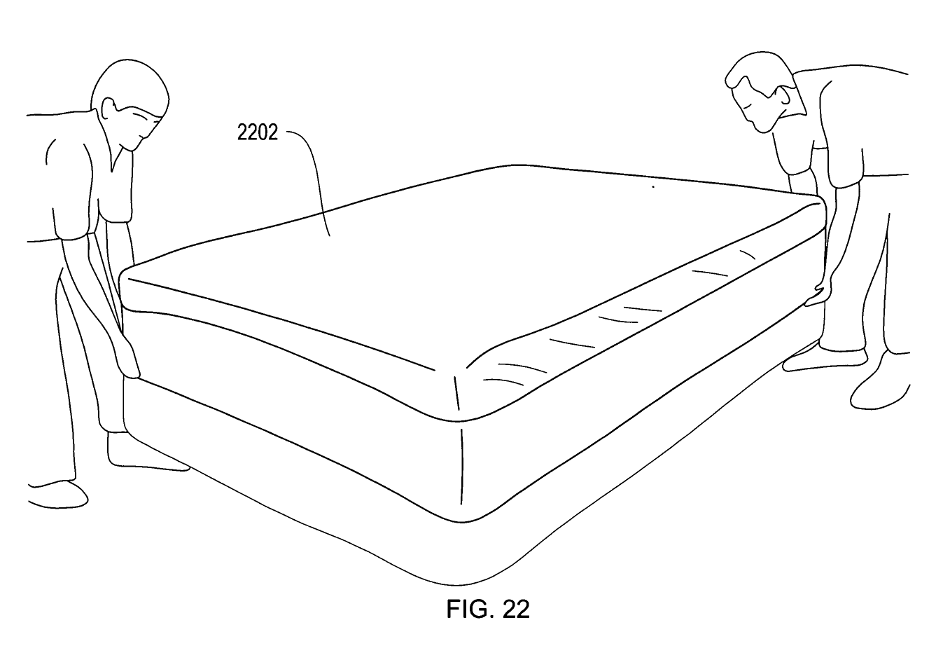

One unzips the bottom material from the cover. The bottom material may be temporarily set aside. The top material 2202 of the mattress cover 2102 is placed on top of the fire retardant mattress core 2000. Two people grasp opposite comers of the mattress cover 2202 and stand at two opposite comers of the fire retardant mattress core 2000 (FIG. 22). They then place the mattress cover 2202 on top of the fire-retardant mattress core 2000 in alignment with the core. The corner seams of the cover 2202 are aligned with the comers of the fire retardant mattress core 2000; this will generally create good quality tailoring once the top material is zipped to the bottom material.

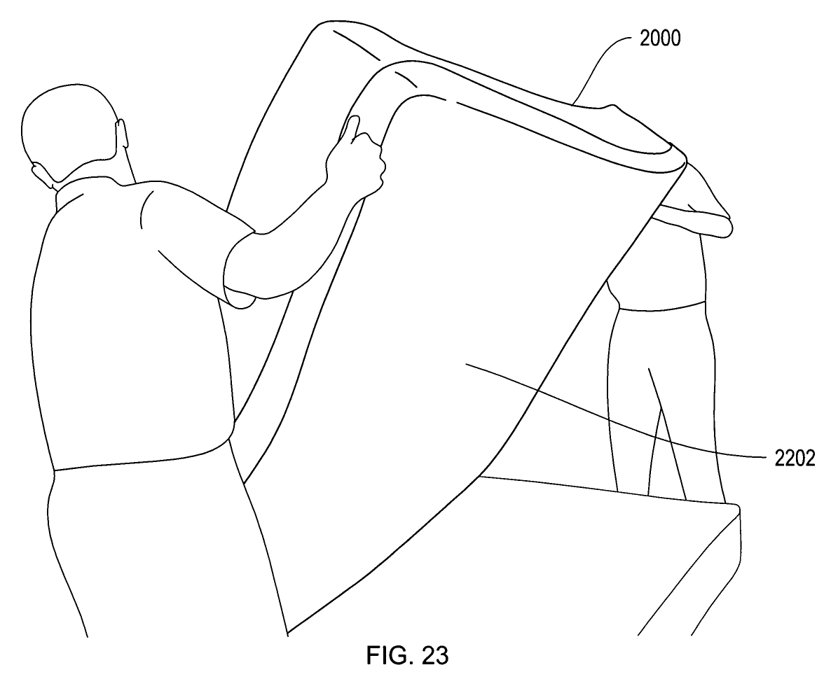

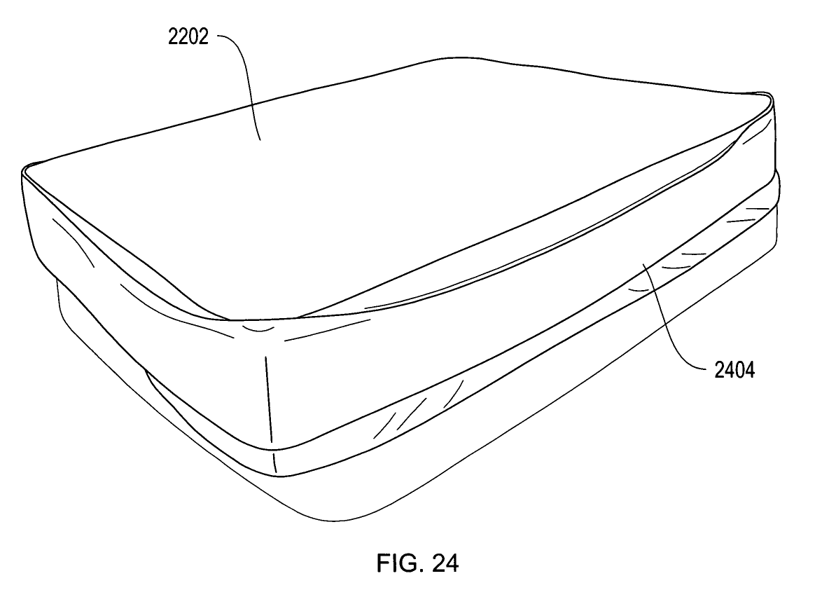

Two people flip the fire retardant mattress core 2000 with the top material 2202 in a controlled manner (FIG. 23), using safe lifting techniques, such that the bottom side of the mattress now faces upwards. A controlled flip may be used to prevent the top material 2202 from shifting relative to the fire retardant mattress core 2000. The bottom material 2402 is aligned on the fire retardant mattress core 2000 (FIG. 24).

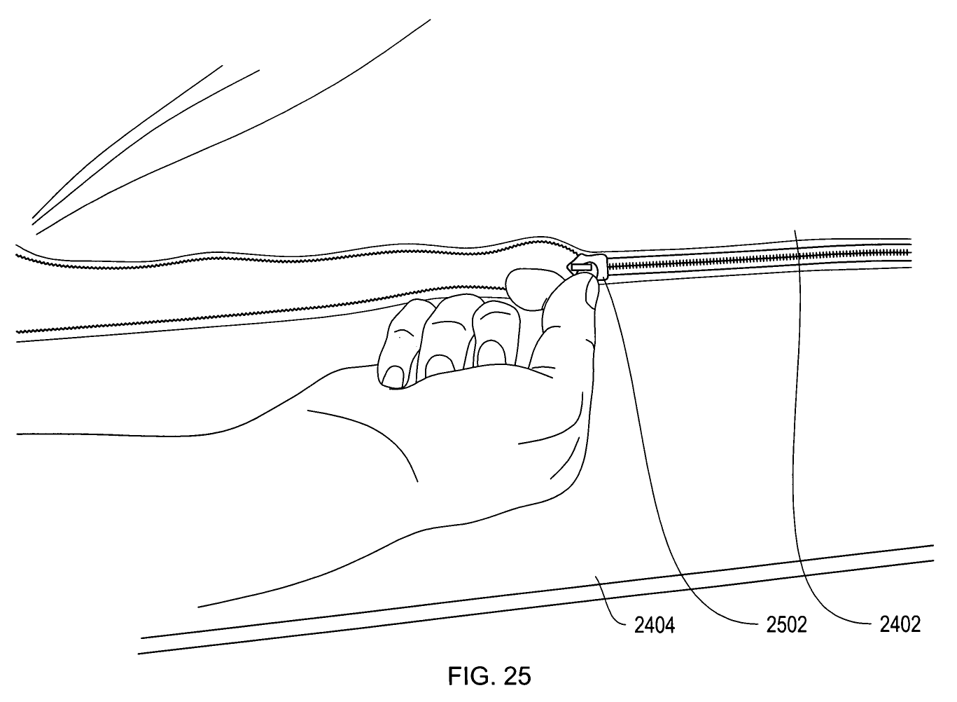

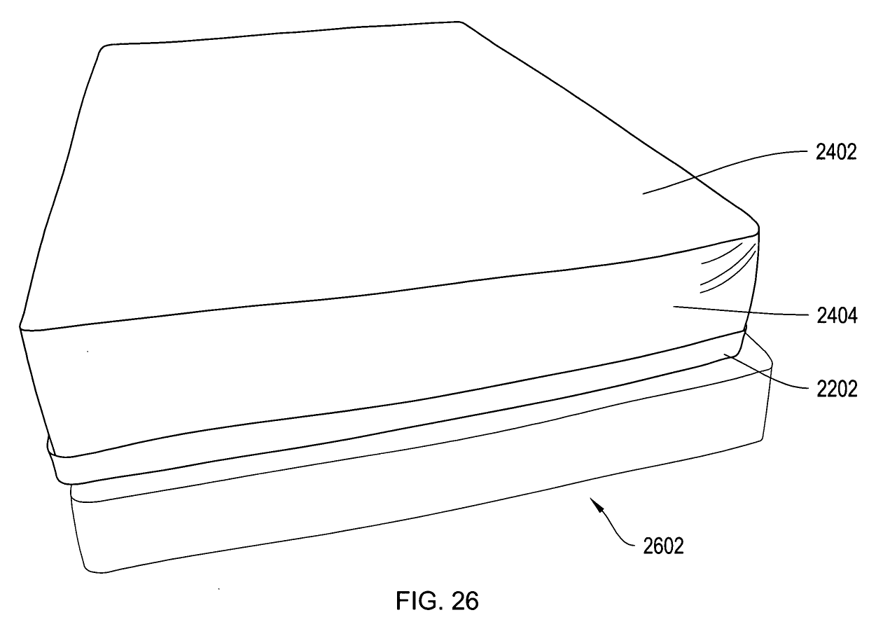

The side material 2404, which is long strips that will cover the sides of the mattress 2000, is aligned along the sides of the mattress 2000 (FIG. 25). The border 2404 is zipped to the bottom material 2402 (FIG. 26), and proper alignment of the cover is maintained by pulling up on the border while zipping. One zips carefully to avoid zipping the sock into the zipper 2502. The zipper 2502 is kept aligned with the bottom edge of the fire retardant mattress core 2000 in order to avoid the bottom material 2402 being visible on the sides of the mattress.

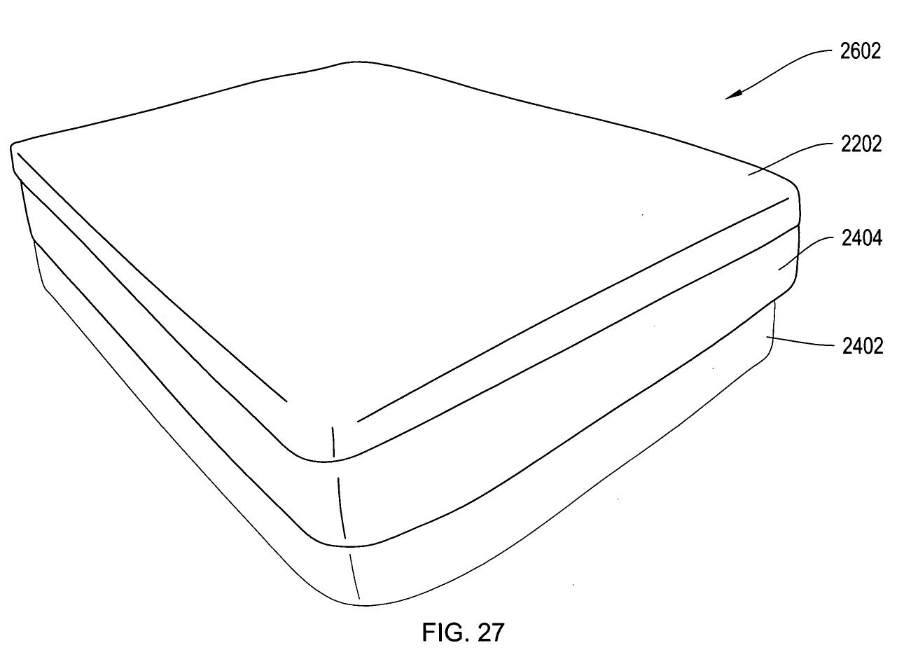

The fire-retardant mattress 2602 assembled using the methods herein may be inspected (FIG. 27). In certain embodiments, one determines whether the mattress cover is taut; the mattress may fail quality control testing if the mattress cover is not taut. One may determine whether the comers of the mattress cover align with the comers of the fire-retardant mattress core; the mattress may fail quality control testing if the comers are not aligned. One may determine whether the mattress cover has wrinkles or creases; the mattress may fail quality control testing if the mattress cover has either. One may determine whether the bottom material of the mattress cover is visible on the sides of the mattress; the mattress may fail quality control testing if the bottom material of the mattress cover is visible on the sides of the mattress.

Having described the illustrated embodiment, the systems and methods described herein will be understood to provide for a method for manufacturing a mattress, and these methods may be broadly understood to include methods that place a fire retardant sleeve or sock around a mattress core, use tape to affix the fire retardant sleeve or sock to the mattress core, and encapsulate the fire-retardant sleeve or sock and mattress core in a mattress cover.

Variations, modifications, and other implementations of what is described may be employed without departing from the spirit and scope of the invention. More specifically, any of the method, system and device features described above or incorporated by reference may be combined with any other suitable method, system or device features disclosed herein or incorporated by reference, and is within the scope of the contemplated inventions. The systems and methods may be embodied in other specific forms without departing from the spirit or essential characteristics thereof. The foregoing embodiments are therefore to be considered in all respects illustrative, rather than limiting of the invention. The teachings of all references cited herein are hereby incorporated by reference in their entirety.

1. A mattress assembly, comprising:
a mattress core,
a fire retardant sleeve fitted over the mattress core, and
a mattress cover enclosing the mattress core and the fire retardant sleeve,
wherein the fire retardant sleeve is attached to the mattress core with adhesive tape.

2. The mattress assembly of claim 1, wherein the mattress core includes at least one of a foam core, an innerspring core, a latex core and a visco elastic core.

3. The mattress assembly of claim 1, wherein one or more portions of the fire retardant sleeve are attached to itself with adhesive tape.

4. The mattress assembly of claim 1, wherein the tape includes a two sided adhesive tape.

5. The method of claim 1, wherein the adhesive tape includes one or more adhesive tape strips.

6. The method of claim 1, wherein the adhesive tape includes one or more strips of at least one of one-sided adhesive tape and two-sided adhesive tape.

7. The mattress assembly of claim 1, wherein the fire retardant sleeve is configured as a sock having an opening on one end, and wherein the sock attaches to the mattress core near the opening.

8. The mattress assembly of claim 7, wherein the sock includes one or more flaps formed from cuts made near the opening on the sock.

9. The mattress assembly of claim 8, wherein the cuts include mitered cuts.

10. The mattress assembly of claim 8, wherein the adhesive tape secures the flaps to the mattress core.

11. The mattress assembly of claim 8, further comprising adhesive tape for securing one or more flaps to another one of the one or more flaps.

12. The mattress assembly of claim 1, wherein the fire retardant sleeve is configured as a tubular sleeve having two openings, and wherein the tubular sleeve attaches to the mattress core near the openings.

13. The mattress assembly of claim 12, wherein the tubular sleeve includes one or more flaps formed from cuts made near the opening on the tubular sleeve.

14. The mattress assembly of claim 13, wherein the adhesive tape secures the flaps to the mattress core.

15. The mattress assembly of claim 13, further comprising adhesive tape for securing one or more flaps to another one of the one or more flaps.

16. The mattress assembly of claim 1, wherein the fire retardant sleeve is attached to the mattress core along at least one of a left side surface, a right surface, a sleeping surface, a bottom surface, a head surface and a foot surface.

17. The mattress assembly of claim 1, wherein the adhesive tape includes a fire retardant adhesive tape.

18. The mattress assembly of claim 1, wherein the mattress cover includes a bottom material and a top material, wherein a zipper removably attaches the top material to the bottom material.

19. The mattress assembly of claim 1, wherein the mattress cover includes a bottom material, a top material and a side border material, wherein a plurality of zippers removably attach the top material to the side border material, and the side border material to the bottom material.

20. A method of manufacturing a mattress, comprising
providing a mattress core,
applying an adhesive tape to one or more surfaces on the mattress core,
sliding a fire retardant sleeve having at least one opening over the mattress core,
forming one or more flaps on the fire retardant sleeve by making cuts on the fire retardant sleeve near the at least one opening,
securing the one or more flaps to the adhesive tape thereby securing the fire retardant sleeve to the mattress core, and
disposing a mattress cover over the fire retardant sleeve and the mattress core.

21. The method of claim 20, further comprising applying one or more additional strips of adhesive tape to at least one portion of the one or more flaps.

22. The method of claim 21, further comprising securing at least one of the one or more flaps to the one or more additional strips of adhesive tape.

23. The method of claim 20, wherein the adhesive tape includes a two-sided adhesive tape having a backing layer on each side.

24. The method of claim 23, wherein applying the adhesive tape includes removing the backing layer on one side and securing the adhesive tape to a surface of the mattress core.

25. The method of claim 20, wherein applying the adhesive tape includes applying one or more adhesive tape strips to the mattress core.

26. The method of claim 20, wherein applying the adhesive tape includes applying one or more strips of at least one of one-sided adhesive tape and two-sided adhesive tape.

27. The method of claim 20, wherein the cuts include mitered cuts.

28. The method of claim 23, wherein securing the one or more flaps includes removing the backing layer on the other side of the adhesive tape and attaching the one or more flaps to the adhesive tape.

29. The method of claim 20, comprising trimming excess fire retardant sleeve material from the one or more flaps.

30. The method of claim 20, wherein the mattress cover includes a top material, a bottom material and a side border material, and wherein disposing the mattress cover includes disposing the top material on a top surface of the mattress core, disposing the bottom material on a bottom surface of the mattress core, and attaching a side border material to the top material and the bottom material along a side surface of the mattress core.
